(19) United States
(12) Patent Application Publication
(10) Pub. No.: US 2017/0031704 A1
(43) Pub. Date: Feb. 2, 2017

(54) NETWORK PORT PROFILE FOR VIRTUAL MACHINES USING NETWORK CONTROLLER

(71) Applicant: HEWLETT-PACKARD DEVELOPMENT COMPANY, L.P., Houston, TX (US)

(72) Inventors: Sonu Sudhakaran, Bangalore (IN); Saro Chandra Bhooshan Thazhath Veettil, Bangalore (IN)

(21) Appl. No.: 15/222,046

(22) Filed: Jul. 28, 2016

(30) Foreign Application Priority Data
Jul. 31, 2015 (IN) 3952/CHE/2015

(51) Int. Cl. G06F 9/455; H04L 29/08; G06F 17/30; H04L 12/931

(52) U.S. Cl. CPC G06F 9/45558; H04L 49/70; H04L 67/303; G06F 17/30091; G06F 17/30377; G06F 17/30088; G06F 2009/45579; G06F 2009/45595

(57) ABSTRACT

Example embodiments disclosed herein relate to use of a network controller to determine or create a network port profile for a virtual machine snapshot. In one example, the network controller receives a request from a virtual machine manager to create a network port profile for a virtual machine associated with a virtual machine identifier. In the example, a network port profile is created based on the virtual machine identifier. In the example, the network port profile includes port information about a virtual machine port associated with the virtual machine identifier, a virtual switch associated with the virtual machine port, and a physical switch port associated with the virtual switch.

### BACKGROUND

Service providers and manufacturers are challenged to deliver quality and value to consumers, for example by providing emulated computing in the form of virtual machines. A virtual machine is the implementation of a machine that executes programs like a physical machine. A virtual machine snapshot can be used to preserve a state of the virtual machine at a point in time.

### BRIEF DESCRIPTION OF THE DRAWINGS

The following detailed description references the drawings, wherein:

FIG. 1 is a block diagram of a system including a network controller capable of determining network port profiles to be stored for a virtual machine snapshot, according to an example;

FIGS. 2 and 3 are block diagrams of network controllers capable of determining network port profiles to be stored for a virtual machine snapshot, according to various examples;

FIG. 4 is a flowchart of a method for creating a network port profile for a virtual machine snapshot, according to an example;

FIG. 5 is a block diagram of a software defined networking controller capable of creating a network port profile for a virtual machine snapshot, according to an example;

FIG. 6 is a flowchart of a method for requesting a software defined network controller to generate a network port profile during a disk image snapshot of a virtual machine, according to an example;

FIG. 7 is a block diagram of a virtual machine manager capable of creating a network port profile for a virtual machine snapshot, according to an example; and

FIG. 8 is a flowchart of a method for initiating a new virtual machine to use a network port profile based on a saved snapshot, according to an example.

### DETAILED DESCRIPTION

Service providers and manufacturers are challenged to deliver quality and value to consumers, for example by providing emulated computing in the form of virtual machines. A virtual machine (VM) is the implementation of a machine that executes programs like a physical machine. A virtual machine snapshot can be used to preserve a state of the virtual machine at a point in time. For example, a VM snapshot may include virtual machine settings, the state of each of the VM's virtual disks, contents of the virtual machine's memory, combinations thereof, etc.

Using virtualization technology, creating and responding to changes in a complex environment can be more easily dealt with using the snapshotting concept. Snapshot can be created that could serve as a template to a working base or application image. Further, several clones can be created out of this snapshot. Moreover, snapshots can be used to revert back to if an error occurs in a running virtual machine.

In one example, a VM snapshot in the virtualization context is a copy of the Virtual Machine's disk file and/or other information (e.g., a memory dump of the Virtual Machine's memory) at a given point in time. In some examples, snapshots provide a change log for a Virtual Disk and are used to restore a VM to a particular point in time when a failure or system error occurs. VM snapshots have other aspects that play roles in the functioning of the VM and installed applications while it is restored from a previous snapshot.

With evolving complexity of applications running on these virtual machines (or virtual servers), supporting virtual network infrastructure (such as virtual switches, virtual ports, etc.), and the backend physical infrastructure (e.g., host NICs, switch ports, etc.) play a major role in functioning of the application when deployed. The administrator can preserve the application and its configuration using the conventional snapshotting mechanism supported by a virtualization vendor, however the virtual and associated physical network configurations may be lost. To re-create the network configuration, a person may have to understand the application behavior (e.g., virtual local area network (VLAN) access, bandwidth reservation, etc.) or have to refer to documentation. It can be challenging to determine the correct configuration without troubleshooting and debugging.

For example, an application administrator may have applied different types of networking configuration on the Virtual Machine ports or Virtual Network Interface Cards (NICs) that would ensure the functioning of the application running inside the Virtual Machine. In a snapshot, because the VM's networking port profile is not captured and saved along with the related artifacts, the administrator may have to re-do the network configurations and apply the port profile correctly once again to the VM once the disk snapshot is restored. In a Software Defined Networking (SDN) scheme, where the hardware and software elements in a networking environment can be controlled from an external network controller, it is desirable to capture the Virtual Machine's port profile(s) and apply the profile(s) as part of the snapshot procedure.

Accordingly, various examples described herein enable the capturing of the network port profile(s) of a Virtual Machine along with its disk image snapshot in a separate model. The approaches described herein further allow for the programming of the related hardware and software infrastructure to support the network port profile of the running Virtual Machine. This includes programming virtual switches on the virtualization host as per the port profile captured and including basic flows in the virtual and physical bridges to enable the virtual machine to communicate in the networking environment. For each snapshot taken for the virtual machine, a network port profile can be captured and stored. Upon the restoration of a particular snapshot, the network port profile is retrieved and applied accordingly on the virtual and physical infrastructure. The approach can improve the ability of backup and restoration of network configuration for the Virtual Machine(s).

In certain examples, network port profile is a set of networking attributes that can be applied to a virtual machine. The application of a network port profile for virtual machine can result in configuring the network infrastructure that the virtual machine connects to. In certain examples, the network port profile can be used to represent networking attributes like: Quality of Service (QoS), Media Access Control (MAC) addresses, Access Control Lists (ACLs), bandwidth settings, packet filtering, flow control, traffic priority, Virtual Local Area Network (VLAN) tags, MAC addressNLAN pairs, combinations thereof, etc. Further, the attributes can be implemented at various layers of the network. As used herein, the network port profile includes at least one port attribute for a virtual port, port group, or virtual switch. Further, as used herein the network port profile also includes at least one port attribute for a physical port. As described herein, information about the virtual machine can be determined using a virtual machine manager and information about physical ports and/or virtual ports can be determined using a network controller.

A benefit of this approach is that a virtual machine may not have requisite knowledge of each of the physical ports (e.g., network interfaces) of the host machine that it runs on. As such, the network controller can be used to determine and store attributes about physical ports used by the virtual machine. In some examples, the network controller can further include information about attributes used on virtual ports of the virtual machine.

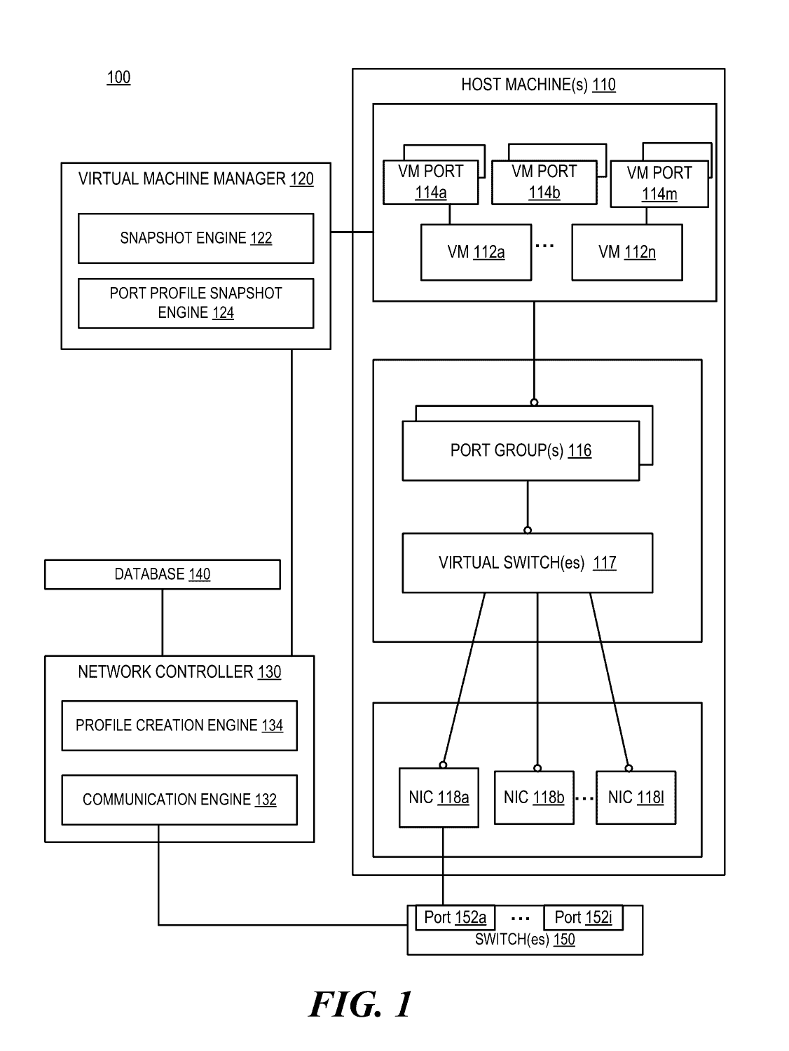

FIG. 1 is a block diagram of a system including a network controller capable of determining network port profiles to be stored for a virtual machine snapshot, according to an example. The system 100 can include a host machine 110 that includes virtual machines 112a-112n. The VMs 112 can use VM ports 114a, 114b-114m. One VM port 114a or additional ports (e.g., VM port 114b, etc.) can be used with particular VMs (e.g., VM 112a). A port group 116 can be used to configure settings in VM ports 114 in a particular port group. In some examples, the VM ports 114 can be thought of as virtual Network Interface Cards (NICs). Further, virtual switch(es) 117 can be implemented to use physical NICs 118a-118l. The NICs 118 can connect to a network of switches 150 via physical ports 152a-152i of the respective switches 150. The switches 150 may be controlled by a network controller 130. As noted above, it can be advantageous to take snapshots of VMs 112.

The snapshotting operation on a VM 112a can be triggered from a Virtual Machine Manager 120 via a snapshot engine 122. The VM 112a can be associated with a virtual machine identifier that identifies the VM 112a. In one example, a user or automated process can initiate the snapshot using snapshot engine 122. The virtual machine manager 120 can be used as an administration console.

The snapshot engine 122 can initiate cloning of the virtual disk image(s) and/or virtual memory of the VM 112a. The snapshot engine 122 can further assign a snapshot identifier to the snapshot. Further, in this example, a port profile snapshot engine 124 can be run to initiate a snapshot of the network port profile associated with a VM port 114a or multiple VM ports associated with the particular VM 112a. The network port profile can include attributes at various layers of the network. Network attributes control traversability over the network. Network attributes specify properties of junctions, edges, and turns used as input for network solvers, such as travel time for road segments, speeds along a road, whether a given road is one way, securing the roads, etc.

In some examples, the port profile snapshot engine 124 can request, from the VM 112a, virtual networking information about the VM 112a. The virtual networking information can include information about a VM port 114a of the VM 112a.

TABLE 1
Example of VM Port Configuration Attributes
Allow HTTP on 8081
Allow ICMP
Ingress Limit = 2 Mbps
Egress Limit = 1 Mbps

In this example, the VM port 114a includes a setting to allow Hypertext Transfer Protocol (HTTP) access on port 8081. Further it allows for the use of Internet Control Message Protocol (ICMP) rules for the ports. Traffic shaping rules such as Ingress/Egress limits can be used to limit the rate of access the VM port 114a has to a physical NIC that is shared with other VMs 112 of the host machine 110. Other information that may be included include security rules, port ACLs, dis-allowing or allowing Dynamic Host Configuration Protocol (DHCP) traffic on the port, bandwidth limiting configuration, flow priorities, other traffic shaping rules, etc. that are applied to the VM port 114a directly. Additional settings may be collected from the port group(s) 116 level, where multiple VM ports 114 can be configured as a group. The virtual networking information can also include the port group information.

TABLE 2
Example of VM Port Group Attributes
AVG B/W = 1 Mbps (IN)
Burst Size = 500 Kbps
VLAN (ID) = 1124
Allow HTTP, ICMP, DNS

As noted, the state and configuration the port group(s) 116 can be captured. Example configurations that can be captured include Virtual Local Area Network (VLAN) tags (e.g., a Level 2 segment id), average bandwidth, peak bandwidth allowed, ingress and egress traffic limiting, traffic/flow priority settings, a number of dvports in the group, whether to allow particular traffic (e.g., HTTP, ICMP, Domain Name System (DNS), etc.), etc. The virtual networking information can also include information about virtual switches 117.

TABLE 3
Example of VM Port Group Attributes
VLAN Type = VLAN PVLAN
VLAN TRUNK = 1124, 1167, 1527
PVLAN ID= 101,103
AVG B/W= 10 Mbps
INGRESS LIMIT = 4 Mbps
EGRESS LIMIT = 4 Mbps

Further, the port profile snapshot engine 124 can capture configuration(s) that are applied at the level of the virtual switch(es) 117 used by the VM 112a. Example configurations that can be captured include VLAN tag (L2 segment id), private VLAN (PVLAN) configuration, average bandwidth, peak bandwidth allowed, ingress and egress traffic limiting, traffic/flow priority setting, number of port groups (VLANs) on the switch, VLAN trunk configuration (which can be used to propagate the definitions of the VLAN to the rest of the network), etc. Other configurations that can be captured at the virtual switch level include configurations pertaining to Physical NICs 118a-118i and/or interfaces available on the virtual switch 117 (e.g., configurations such as NIC bonds, NIC team, teaming mode, etc.).

The port profile snapshot engine 124 can also capture it captures details about the host machine 110. The details can include a unique hostname, IP Addresses, MAC Addresses of physical ports, etc.

The virtual machine manager 120 can send a communication to the network controller 130, via a communication engine 132, which includes the details collected by the port profile snapshot engine 124. In some examples, the communication can be in the form of a request to the network controller 130 (e.g., a software defined networking controller) that controls a network connected to the VM 112a to create a network port profile for the VM 112a. The request can include a virtual machine identifier. Moreover, the request can include a snapshot identifier and can be send in response to the initiation of the snapshot of VM 112a.

The network controller 130 can receive the request via a communication engine 132. The communication can be on a control plane, a data plane, or via another communication approach. In some examples, the network controller 130 and the virtual machine manager 120 may be implemented on a single device.

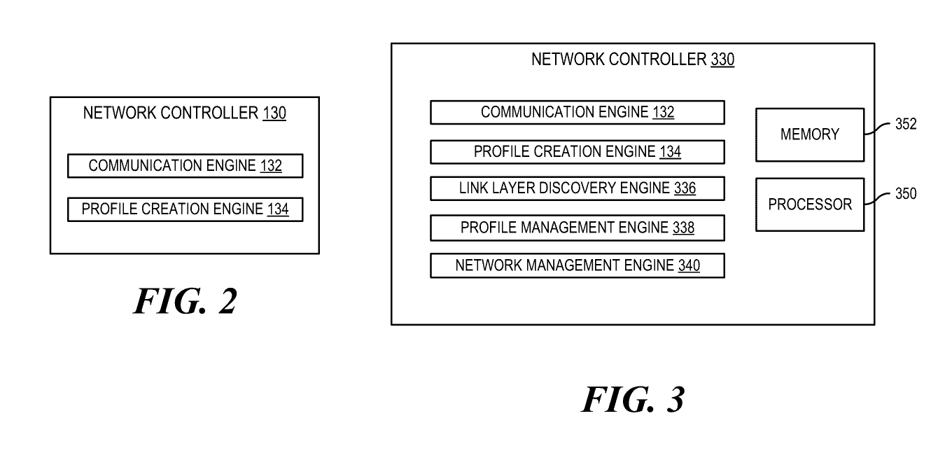

FIGS. 2 and 3 are block diagrams of network controllers 130, 230 capable of determining port profiles to be stored for a virtual machine snapshot, according to various examples. The communication engine 132 receives the request from the port profile snapshot engine 124.

Profile creation engine 134 can create a network port profile for the VM 112a based on the request identifying the VM 112a, the captured state information received from the port profile snapshot engine 124, and information about the network infrastructure known to the network controller 130. The network port profile can include attributes directly set for a VM port 114a or multiple VM ports associated with the VM 112a, information about any port groups 116 associated with the VM port(s), attributes associated with any virtual switch(es) 117 associated with the respective VM port(s), associations of the virtual switch(es) used by the VM 112a to physical NIC(s) 118, etc. Further, the network port profile can include attributes set at a port 152a or multiple ports of a switch 150 or multiple switches 150 controlled by the network controller 130 and used by VM 112a. The network port profile can be created by initiating a new data structure at the network controller 130 or by modifying a data structure captured by the port profile snapshot engine 124. In some examples, the network port profile can be stored in database 140. In other examples, the network port profile can be provided to the snapshot engine 122 to store with the VM snapshot. In some examples, the network port profile can be associated with the virtual machine identifier and/or snapshot identifier.

Physical ports 152 of the switch(es) 150 associated with the VM 112a can be determined using a link layer discovery engine 336. A protocol can be used, such as the link layer discovery protocol, proprietary discovery protocols, other link layer topology discovery mechanisms, etc. The approach can be used to advertise identities of network devices, capabilities, and neighbors. Information gathered with the link layer discovery engine 336 can be stored in the database 140 or other database such as a management information database. A network management protocol can be used to query devices. The topology of the network infrastructure can be discovered by crawling hosts and querying the management information database. Examples of information that can be retrieved using this approach include a system name and description, port name and description, VLAN name, Internet Protocol (IP) management address, system capabilities of a network device, MAC information, physical layer information, link aggregation, etc. Moreover, network attributes associated with the physical network ports can be determined using the link layer discovery engine 336. Information (e.g., VLAN names) gathered by the link layer discovery engine 336 can be used to tie the physical port(s) 152 of the switch(es) 150 to the virtual switches 117 based on correlation with captured information about the VM 112a. In certain examples, the network controller 130 instead of the virtual machine manager 120 can capture the information about the VM 112a. The information can be captured, for example, via an application programming interface to the VM 112a, the host machine 110, and/or a layer of abstraction between the VM 112a and the host machine 110.

The information can be maintained by the network controller 130. As such, the network controller 130 can use the approaches described to discover the host machine(s) 110, attributes of the physical ports (e.g., link aggregation type, VLAN type, identifiers, physical switch port ACL(s) connecting the physical NIC(s) of the host machine 110 to the physical switch(es) 150), other information about the devices (e.g., associated MAC information, IP addresses, etc.), etc.

In some examples, the switch(es) 150 and other network devices making up the network infrastructure controlled by the network controller 130 can use a discovery protocol to gather information and provide it to the network controller 130. A profile management engine 338 can be used to maintain a database including network port information associated with the network infrastructure. The information can include network attributes and the data can be gathered through network devices and/or from other sources (e.g., virtual machines). The maintained information can be determined before the request is received and/or be updated after the request is received.

In response to receiving the request, the profile creation engine can associate the physical configuration of the host machine's 110 physical NIC(s) and the profile of the physical switch port(s) 152 used by the VM 112a to the VM's 112a captured port profile. Further, as noted, the database of information about the network infrastructure can be updated.

In some examples, the profile management engine 338 can maintain a database 140 including the created network port profile information. The database can include information about the associated snapshot identifier, a virtual machine identifier, a time of the snapshot, etc. This information can be used to later provision the network configuration based on the captured network profile. In some examples, the communication engine 132 can be used to send the network port profile to the virtual machine manager 120. In some examples, the snapshot engine 122 can store the network port profile for the VM 112a with the snapshot. The snapshot engine 122 can complete the snapshot of the VM 112a.

The network controller 330 can use a network management engine 340 to control management of switch(es) 150 and other network devices using the network infrastructure. For example, the network management engine can implement a protocol, such as a flow protocol to indicate to switches and other network devices where to send packets.

At a later point in time, a snapshot can be used to create a new virtual machine on a host machine. This can occur, for example, when there is a reversion to the snapshot, if the snapshot is used to clone the VM 112a, etc. The snapshot can be the snapshot created above or another snapshot similarly created.

The host machine can be the same host machine 110 as the VM 112a or a different host machine. The snapshot engine 122 can cause the host machine 110 to initialize the new instance of the virtual machine. During the initialization process, the new instance can be associated with a new virtual machine identifier and use the same snapshot identifier.

The profile management engine 338 can look up the snapshot identifier and/or the VM identifier in its database and fetch the records related to the particular snapshot identifier. The network controller 130 can cause the virtual machine manager 120 to create VM ports for the new virtual machine and configure the ports based on attributes in the port profile (e.g., based on port groups and/or individual VM port associations). Further, the network controller can use a network management engine 340 to set port properties based on the network port profile associated with the snapshot identifier. Moreover, the network management engine 340 can attach the NIC(s)/Ports to the virtual switches used.

During the initialization process, the snapshot engine 122 can further request that the network controller 130 restore one or more settings from the network port profile associated with the snapshot identifier. The database 140 can be updated to apply the settings from the network port profile. Further, the respective switch(es) 150 associated with the new virtual machine can be updated with the port attributes. A notification can be relayed back to the virtual machine manager 120 to notify an administrator that the task is complete.

In some examples, the network port profile may be updated separate from the snapshot. For example, if a security patch is being implemented using network attributes, the changes can be made as an update to the network port profiles for respective virtual machines with virtual machine snapshots. As such, when a new snapshot is initialized with a modified network port profile, the updated network attributes can also be implemented. As noted above, the virtual machine identifier and/or snapshot identifier can be used to determine the network port profile. An additional identifier can be added (e.g., a version number) to distinguish that the network port profile has been modified.

The engines 122, 124, 132, 134, 336, 338, 340 can include hardware and/or combinations of hardware and programming to perform functions provided herein. Moreover, the modules (not shown) can include programing functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

A processor (e.g., processor 350 of network controller 330), such as a central processing unit (CPU) or a microprocessor suitable for retrieval and execution of instructions and/or electronic circuits can be configured to perform the functionality of any of the engines described herein. In certain scenarios, instructions and/or other information, such as network port profiles, can be included in 352 for example, memory 352 of the network controller 330. Input/output interfaces may additionally be provided by devices.

In some examples, the engines may be implemented as modules (not shown). Modules may include, for example, hardware devices including electronic circuitry for implementing the functionality described herein. In addition or as an alternative, each module may be implemented as a series of instructions encoded on a machine-readable storage medium of a computing device and executable by processor. It should be noted that, in some embodiments, some modules are implemented as hardware devices, while other modules are implemented as executable instructions.

In certain examples, devices can communicate using a network infrastructure. A communication network can use wired communications, wireless communications, or combinations thereof. Further, the communication network can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network can be in the form of a direct network link between devices. Various communications structures and infrastructure can be utilized to implement the communication network(s).

By way of example, devices can communicate with each other and other components via a communication protocol or multiple protocols. A protocol can be a set of rules that defines how nodes of the communication network interact with other nodes. Further, communications between network nodes can be implemented by exchanging discrete packets of data or sending messages. Packets can include header information associated with a protocol (e.g., information on the location of the network node(s) to contact) as well as payload information.

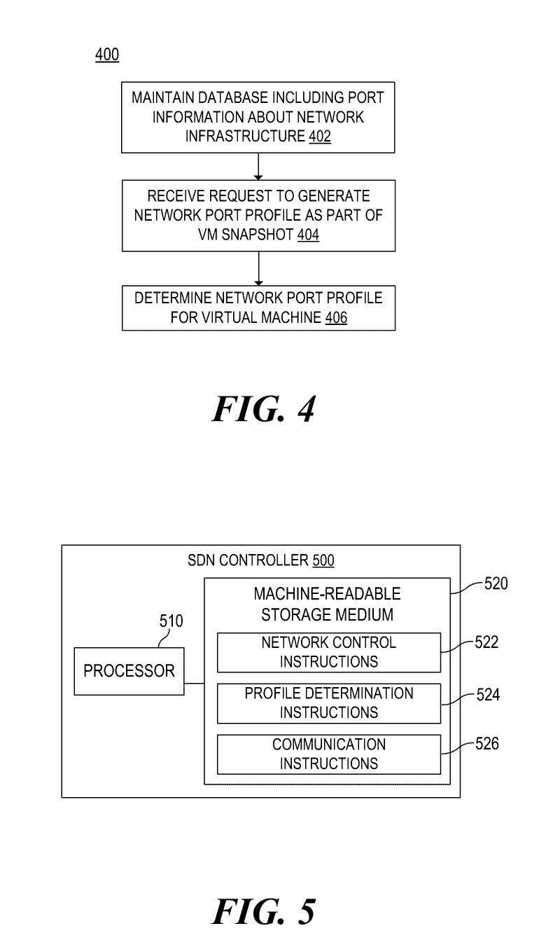

FIG. 4 is a flowchart of a method for creating a network port profile for a virtual machine snapshot, according to an example. FIG. 5 is a block diagram of a software defined networking controller capable of creating a network port profile for a virtual machine snapshot, according to an example. Although execution of method 400 is described below with reference to SDN controller 500, other suitable components for execution of method 400 can be utilized (e.g., components of system 100). Additionally, the components for executing the method 400 may be spread among multiple devices. Method 400 may be implemented in the form of executable instructions stored on a machine-readable storage medium, such as storage medium 520, and/or in the form of electronic circuitry.

The SDN controller 500 includes, for example, a processor 510, and a machine-readable storage medium 520 including instructions 522, 524, 526 for determining a network profile based on a database. SDN controller 500 may be implemented, for example, on a computing device such as a server, a workstation, a notebook computer, etc.

Processor 510 may be, at least one central processing unit (CPU), at least one semiconductor-based microprocessor, at least one graphics processing unit (GPU), other hardware devices suitable for retrieval and execution of instructions stored in machine-readable storage medium 520, or combinations thereof. For example, the processor 510 may include multiple cores on a chip, include multiple cores across multiple chips, multiple cores across multiple devices (e.g., SDN controller 500 works in conjunction with other SDN controllers), or combinations thereof. Processor 510 may fetch, decode, and execute instructions 522, 524, 526 to implement determination of a network port profile. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526.

Machine-readable storage medium 520 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 520 may be encoded with a series of executable instructions for determining network port profiles.

At 402, the processor 510 can execute network control instructions 522 to maintain a database including port information about a network infrastructure. The network infrastructure may be associated with a network device or multiple network devices (e.g., switches, routers, etc.) controlled using the SDN controller 500. The network infrastructure can also be used by a device that includes one or more virtual machines. A virtual machine manager can also be associated with the virtual machines. While maintaining the database, the SDN controller 500 can use a discovery approach (e.g., using a link layer discover process such as using a link layer discovery protocol, a proprietary discovery protocol, etc.) to determine information about the network infrastructure as noted above. Further, information can be received from the virtual machine manager (e.g., port profile information collected during snapshots or based on a request) to determine virtual ports of virtual machines using the network infrastructure. The SDN controller 500 can be connected to network infrastructure (e.g., via a control plane). The network infrastructure can also be connected to the virtual machines (e.g., via a data plane).

At 404, the communication instructions 526 can be executed by processor 510 to facilitate the SDN controller 500 receiving a request to generate a network port profile as part of a virtual machine snapshot. The request can be received from a virtual machine manager initiating a snapshot of a particular virtual machine. The request can include a virtual machine identifier and a snapshot identifier. As noted above, in some examples, the virtual machine manager may also provide captured port information about the virtual machine.

At 406, profile determination instructions 524 can be executed by processor 510 to determine a network port profile for the virtual machine. The network port profile can include port information about one or more virtual machine port of the virtual machine, one or more virtual switch associated with the virtual machine port, one or more physical NIC associated with the virtual machine, a physical switch port associated with the virtual machine, combinations thereof, etc. As noted above, a portion of the port information (e.g., the virtual port information) can be captured and provided from the virtual machine manager and a portion of the port information (e.g., information about the physical switch ports) is determined from by the SDN controller 500 (e.g., based on the maintained database). In some examples, the database is updated for the virtual machine before the profile is determined. The network port profile can be identified by including the snapshot identifier and/or the virtual machine identifier. In some examples, the network port profile can be stored in a database accessible by the SDN controller 500. A communication can be sent to the virtual machine manager that the network port profile has been created and identification information to access the network port profile.

In some examples, communication instructions 526 can be executed to send the network port profile to the virtual machine manager. This can cause storage of the network port profile with the snapshot by the virtual machine manager. In some examples, storage with the snapshot can include including the network port profile in the snapshot, indexing the snapshot and the network port profile together, etc.

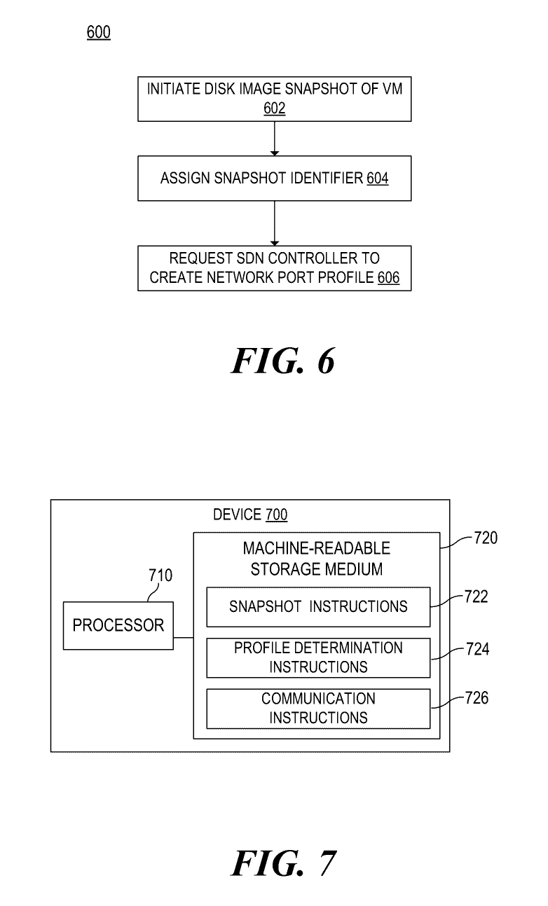

FIG. 6 is a flowchart of a method for requesting a software defined network controller to generate a network port profile during a disk image snapshot of a virtual machine, according to an example. FIG. 7 is a block diagram of a virtual machine manager capable of creating a network port profile for a virtual machine snapshot, according to an example. Although execution of method 600 is described below with reference to device 700, other suitable components for execution of method 600 can be utilized (e.g., virtual machine manager 120, a computing device including virtual machine management capabilities, etc.). Additionally, the components for executing the method 600 may be spread among multiple devices. Method 600 may be implemented in the form of executable instructions stored on a machine-readable storage medium, such as storage medium 720, and/or in the form of electronic circuitry.

The device 700 includes, for example, a processor 710, and a machine-readable storage medium 720 including instructions 722, 724, 726 for facilitating creation of a network port profile using an SDN controller. Device 700 may be implemented, for example, as a computing device such as a server, a workstation, a desktop computer, a laptop, a mobile device, etc.

Processor 710 may be, at least one central processing unit (CPU), at least one semiconductor-based microprocessor, at least one graphics processing unit (GPU), other hardware devices suitable for retrieval and execution of instructions stored in machine-readable storage medium 720, or combinations thereof. For example, the processor 710 may include multiple cores on a chip, include multiple cores across multiple chips, multiple cores across multiple devices (e.g., if the device 700 includes multiple node devices), or combinations thereof. Processor 710 may fetch, decode, and execute instructions 722, 724, 726 to implement network port profile association during a virtual machine snapshot. As an alternative or in addition to retrieving and executing instructions, processor 710 may include at least one integrated circuit (IC), other control logic, other electronic circuits, or combinations thereof that include a number of electronic components for performing the functionality of instructions 722, 724, 726.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for using an SDN controller to create a network port profile. Device 700 can be used to implement a virtual machine manager.

At 602, the snapshot instructions 722 can be implemented by processor 710 to initiate a disk image snapshot of a virtual machine associated with a virtual machine identifier. The snapshot can be initiated in response to an event (e.g., a scheduled event, an indication from an administrator to create the snapshot, etc.).

The device 700 can assign a snapshot identifier to the snapshot at 604. The snapshot identifier can be used to identify the network port profile and/or the snapshot. The device 700 can execute the profile determination instructions 724 to help capture virtual port information about the virtual machine as described above.

At 606, the device 700 can execute communication instructions 726 using the processor 710 to request that a SDN controller managing the network infrastructure (e.g., a switch) used by the virtual machine create a network port profile for the virtual machine. The virtual machine can be identified by a virtual machine identifier. Further, in some examples, the device 700 can send the captured virtual port information to a SDN controller.

The network port profile can include port information about a virtual machine port of the virtual machine, a virtual switch associated with the virtual machine port, and a physical switch port associated with the virtual machine. As noted above, the virtual machine may not have access to the physical information associated with the physical switch and/or one or more interfaces (e.g., NICs) of the host machine used by the virtual machine. As such, the SDN controller is requested to provide that information for the snapshot. In some examples, the SDN controller stores the network port profile in a location accessible to the SDN controller. In one example, this location can also be accessible by the virtual machine manager of device 700.

In another example, the SDN controller sends the network port profile including to the device 700. The device 700 receives the network port profile and causes storage of the network port profile. In one example, the network port profile can be stored with the snapshot of the virtual machine.

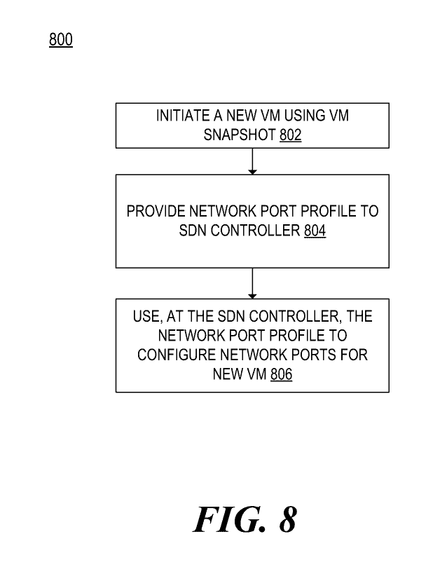

FIG. 8 is a flowchart of a method for initiating a new virtual machine to use a network port profile based on a saved snapshot, according to an example. Execution of method 800 can be implemented using various devices, for example devices of system 100. Other suitable components for execution of method 800 can also utilized.

At 802, a new virtual machine (e.g., a clone or a copy to revert to) can be initiated on a host device using a virtual machine snapshot. A virtual machine manager cause initiation of the new virtual machine on the host machine. This can be accomplished, for example, by requesting that an operating system on the host machine initialize the new virtual machine and providing access/specifying the snapshot. The virtual machine snapshot can be associated with a network port profile using a snapshot identifier. In one example, the network port profile is accessible by the virtual machine manager. A virtual machine identifier and/or a snapshot identifier can be used to identify the profile. In one example, the network port profile for the snapshot identifier is provided to an SDN controller managing a network infrastructure used by the new virtual machine (804). In other examples, the SDN controller may already have access to the network port profile.

During the initiation process, at 806, the SDN controller can be used to configure one or more network ports for the new virtual machine. In one example, a virtual machine manager requests the SDN controller to use the network port profile to set up network port information for the new virtual machine. In some examples, the network ports configured include one or more physical network ports of a physical switch controlled by the SDN controller.

What is claimed is:

1. A network controller comprising:
a communication engine to receive a request from a virtual machine manager to create a network port profile for a virtual machine associated with a virtual machine identifier in response to a snapshot of the virtual machine; and
a profile creation engine to create the network port profile based on the virtual machine identifier,
wherein the network port profile includes port information about a virtual machine port associated with the virtual machine identifier, a port group associated with the virtual machine port, a virtual switch associated with the virtual machine port, and a physical switch port associated with the virtual switch.

2. The network controller of claim 1, further comprising:
a link layer discovery engine to discover a network infrastructure associated with the network controller including the port information about the physical switch port.

3. The network controller of claim 2, further comprising:
a profile management engine to maintain a database including other port information associated with the network infrastructure and the port information.

4. The network controller of claim 3, wherein the network port profile further includes a snapshot identifier associated with the request.

5. The network controller of claim 4, wherein the communication engine receives, from the virtual machine manager, during initialization of a new instance of the virtual machine, a second virtual machine identifier associated with the new instance, and the snapshot identifier, wherein the database is further updated to apply a plurality of settings from the network port profile to a new virtual machine port corresponding to the virtual machine port.

6. The network controller of claim 3, wherein the communication engine receives, from the virtual machine manager, during initialization of a new instance of the virtual machine, a second virtual machine identifier associated with the new instance, and another network port profile taken with another snapshot, wherein the database is further updated to apply a plurality of settings from the other network port profile to a new virtual machine port corresponding to a virtual machine port in the other network port profile.

7. The network controller of claim 1, wherein the communication engine is further to send the network port profile to the virtual machine manager.

8. A non-transitory machine-readable storage medium storing instructions that, if executed by at least one processor of a device, cause the device to:
initiate a disk image snapshot of a virtual machine with a virtual machine identifier;
assign the snapshot a snapshot identifier; and
request, from a software defined networking controller managing a network connected to the virtual machine, a network port profile to be created for the virtual machine based on the virtual machine identifier,
wherein the network port profile includes port information about a virtual machine port of the virtual machine, a virtual switch associated with the virtual machine port, and a physical switch port associated with the virtual machine.

9. The non-transitory machine-readable storage medium of claim 8, further comprising instructions that, if executed by the at least one processor, cause the device to:
initiate a second virtual machine based on the snapshot;
during the initiation process, request that the network port profile be used to set up network port information for the second virtual machine based on the virtual machine identifier and the snapshot identifier,
wherein the network port profile is stored with the software defined networking controller.

10. The non-transitory machine-readable storage medium of claim 8, further comprising instructions that, if executed by the at least one processor, cause the device to:
receive the network port profile including the snapshot identifier and the virtual machine identifier; and
cause storage of the network port profile with the disk image snapshot.

11. The non-transitory machine-readable storage medium of claim 10, further comprising instructions that, if executed by the at least one processor, cause the device to:
provide the network port profile to the software defined networking controller during initiation of a second virtual machine to cause the software defined networking controller to use the network port profile to configure the network ports for the second virtual machine.

12. A method comprising:
maintaining a database, at a software defined networking (SDN) controller, including port information about a network infrastructure;
receiving, at the software defined networking controller, a request from a virtual machine manager to generate a network port profile for a virtual machine associated with a virtual machine identifier in response to initiation of a snapshot of the virtual machine, the snapshot being associated with a snapshot identifier,
wherein the SDN controller is connected to the network infrastructure and the network infrastructure is also connected to the virtual machine,
determining the network port profile based on the database, wherein the network port profile includes port settings about a virtual machine port associated with the virtual machine identifier, a port group associated with the virtual machine port, a virtual switch associated with the virtual machine port, and a physical switch port associated with the virtual switch,
and wherein the network port profile includes the snapshot identifier.

13. The method of claim 12, further comprising:
discovering the port information of the network infrastructure using a link layer discovery process.

14. The method of claim 12, further comprising:
initiating the snapshot of the virtual machine at the virtual machine manager;
associating the snapshot identifier with the snapshot at the virtual machine manager; and
sending the request, by the virtual machine manager, to the SDN controller.

15. The method of claim 14, further comprising:
sending, by the SDN controller, the network port profile to the virtual machine manager; and
causing storage of the network port profile with the snapshot by the virtual machine manager;
initializing a second virtual machine based on the snapshot; and
providing the network port profile to the SDN controller as part of the initialization process.
